(19) United States
(12) Patent Application Publication
(10) Pub. No.: US 2004/0068572 A1
(43) Pub. Date: Apr. 8, 2004

(54) Methods and systems for communicating over a client-server network

(76) Inventor: Zhixue Wu, Cambridge (GB)

Correspondence Address: TESTA, HURWITZ & THIBEAULT, LLP, HIGH STREET TOWER, 125 HIGH STREET, BOSTON, MA, 02110, US

(21) Appl. No.: 10/264,487

(22) Filed: Oct. 4, 2002

(51) Int. Cl. G06F 15/16

(52) U.S. Cl. 709/229

(57) ABSTRACT

The invention relates to a server for communicating over a client-server network. The server includes a receiver receiving a first request from a first client to establish a communication session with the server. The server also has a user session mechanism that establishes a user session in response to the first request. The server additionally includes a client session mechanism that establishes a first client session in response to the first request. Upon termination of the first client session, the server stores user session data in a memory element, which can be, for example, a database. The receiver also receives a second request to establish a communication session with the server from a second client. When receiving this second request, the user session mechanism reactivates the user session.

### FIELD OF THE INVENTION

The present invention relates generally to communicating over a client-server network and, more specifically, to enabling a user operating a first client to disconnect from a communication session with a server and later reconnect to the same session at any time from the same or another client.

### BACKGROUND OF THE INVENTION

Referring to FIG. 1, one type of networked computer system 100 known to the prior art typically includes a client computer 110 and a server 115. The client computer 110 is typically a personal computer that can download information from the server 115. A conventional client 110 communicates with the server 115 over a client-server communication channel 120 that passes through a network 125, such as the Internet or World Wide Web. The server 115 can also host one or more application programs 130 that can be accessed by the client 110.

The client 110 may also include a web browser 135, such as INTERNET EXPLORER developed by Microsoft Corporation in Redmond, Wash. or NETSCAPE NAVIGATOR developed by Netscape Communications Corporation of Mountain View, Calif., to connect to the web and/or download content from the server 115. The server 115 typically delivers web pages to the client 110 (e.g., web browser 135) in response to a communication request from the client 110.

The client 110 and the server 115 traditionally employ the Hypertext Transfer Protocol (HTTP) when communicating over the Internet 125. Unfortunately, however, HTTP is a “stateless” protocol. In other words, each visit to the server 115 is typically seen by the server 115 as the first visit by the user. In essence, the server “forgets” everything after each communication request.

For example, a user operating the client 110 can communicate with the server 115 over the Internet 125. During these communications, the user can use an application 130 executing on the server 115 to, for instance, perform some work. The server 115 also typically stores data associated with the communications. Later, the user ends the communications with the server 115, such as when the user has to leave the area. As a result of the termination of the communications, the server 115 typically deletes the data associated with the communications. When the user subsequently returns to the area to use the same client 110, the user can use the client 110 to again communicate with the server 115. If the user attempts to access the data that the server 115 had stored during the previous communications, the user typically fails because the server 115 no longer has access to the data associated with the previous communications because of the stateless nature of HTTP.

One solution to this problem has been the establishment of an HTTP session. An HTTP session typically refers to the duration of a number of requests to a web page by a single user operating the client 110. During an HTTP session, cookies are typically employed to maintain state. For example, the server 115 can create and send a cookie to the web browser 135 for subsequent storage on the client 110. During an HTTP session, the client 110 typically transmits the data associated with a user's cookie to the server 115 to preserve state.

Further, if the server 115 executes with an Application Service Provider (ASP.NET) module, developed by Microsoft Corporation of Redmond, Wash., the ASP.NET module typically enables HTTP session state to be saved in the server 115. Further, the server 115 can assign an authentication cookie to the client 110 for subsequent identification of the session state. Moreover, only the authentication cookie is transmitted between the client 110 and the server 115, while the session state is stored in the server 115.

The implementation of an HTTP session, even with the use of a cookie, frequently lacks flexibility and robustness. A cookie, for instance, is traditionally limited to a particular client 110. Moreover, conventional HTTP sessions are traditionally suitable for web applications 130 that provide short, simple services. For applications 130 in which the server 115 employs an HTTP session, a user may have to finish the task in a certain short period of time without interruption. If the user idles for too long during a task, the server 115 may terminate the session, again resulting in the loss of the user's data.

For example, when a user wants to purchase an item on-line (e.g., over the Internet 125), the user uses the client 110 to log onto a web page selling the item of interest. The user typically traverses through numerous screens, such as a screen to select the item and a screen to enter personal information (e.g., mailing address). At some point, the user then comes to the screen at which the user has to enter payment information, such as a credit card number. If the user waits too long before providing the user's credit card information, the server 115 often terminates the communication session and forces the user to establish another communication session with the server 115. During this second communication session, the user typically has to re-enter all of the user's data again in a later communication session because of the timeout between the client 110 and the server 115.

Additionally, the user who previously accessed a web page with a client 110 is thereafter “tied” to that client 110 in order to obtain the benefits of the cookie stored on the client 110. Thus, there is a need to increase the flexibility and robustness of a communication session between a client 110 and a server 115.

### SUMMARY OF THE INVENTION

The invention relates to methods and systems for enabling a user to disconnect from a communication session with a web server and then reconnect to the same session anytime, from any place, and via any device. Thus, the above-mentioned limitations associated with a communication session, such as the possibility of losing data when not finishing a task within a predetermined period of time, are alleviated. Moreover, the invention provides increased flexibility and robustness to a communication session because of the lifting of the time limitation and the client limitation typically associated with conventional communication sessions between a server and a client.

In one aspect, the invention relates to a server for communicating over a client-server network. The server includes a receiver receiving a first request from a first client to establish a communication session with the server. The server also has a user session mechanism that establishes a user session in response to the first request. The server additionally includes a client session mechanism that establishes a first client session in response to the first request. Upon termination of the first client session, the server stores user session data in a memory element, which can be, for example, a database. The receiver also receives a second request to establish a communication session with the server from a second client. When receiving this second request, the user session mechanism reactivates the user session. In one embodiment, the user session mechanism assigns a state to an established user session. This state may be an active state, a suspended sate, or a completed state.

In another aspect, the invention relates to a method for communicating over a client-server network. The method includes the step of receiving, by a server, a request to establish communications with the server. A first client operated by a user transmits the request to the server. In response to the received request, a user session between the server and the identified user is established. Similarly, a client session between the first client and the server is also established in response to the received request. The method also includes the step of storing, by the server, user session data in response to termination of the client session. The method also includes the steps of receiving, by the server, a request to establish communications with the server from a second client operated by the user and reactivating the user session.

In one embodiment, the request identifies the user, such as with user authentication credentials. The method may also include receiving a termination message from the first client and terminating the client session between the first client and the server before storing the user session data. In another embodiment, the server terminates the client session between the first client and the server and stores the user session data after waiting a predetermined time. In some embodiments, the method also includes assigning a state to the established user session, such as an active, suspended, or completed state.

The stored user session data can be used to determine the existence of an established user session associated with the user after receiving another request to establish communications with the server. In one embodiment, the user session is reactivated when the existence of the established user session is determined.

### BRIEF DESCRIPTION OF THE DRAWINGS

The advantages of the invention described above, together with further advantages, may be better understood by referring to the following description taken in conjunction with the accompanying drawings. In the drawings, like reference characters generally refer to the same parts throughout the different views. Also, the drawings are not necessarily to scale, emphasis instead generally being placed upon illustrating the principles of the invention.

FIG. 1 is a block diagram of an embodiment of a prior art client-server network.

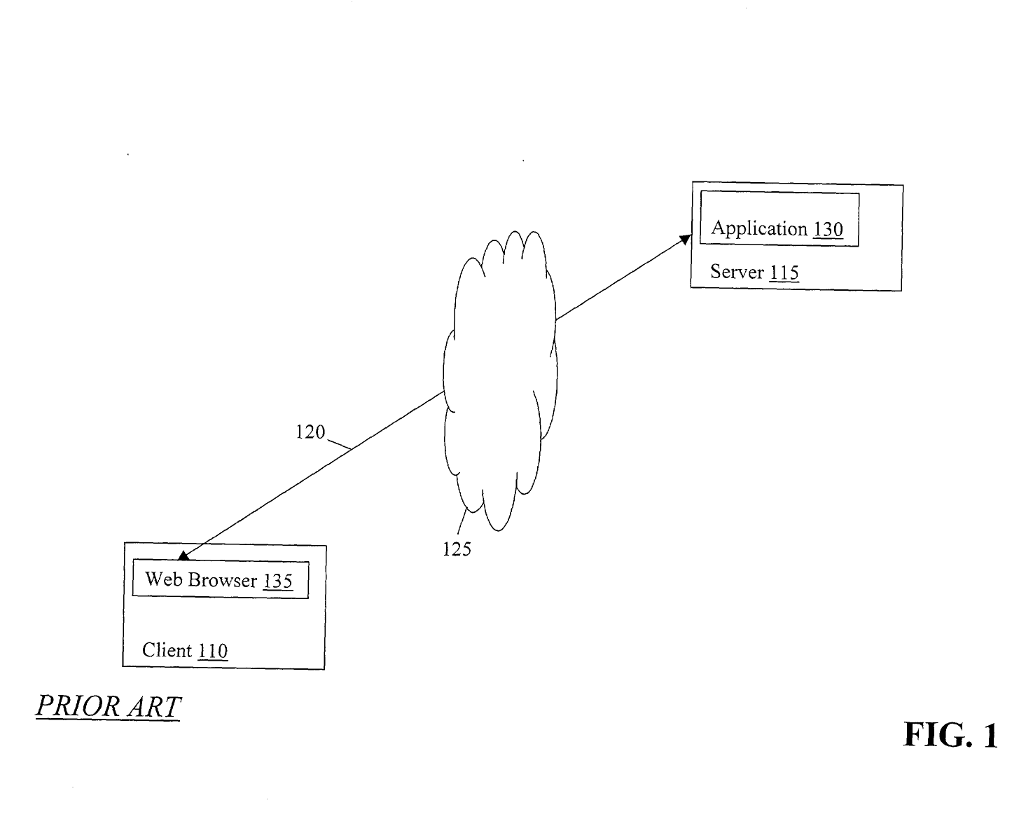

FIG. 2 is a block diagram of an embodiment of a client-server network having a server with a user session mechanism.

FIG. 3 is a more detailed block diagram of an embodiment of a server having a user session mechanism.

FIG. 4 is a flow diagram illustrating an embodiment of the steps performed by the server.

FIG. 5 is a flow diagram illustrating an embodiment of the steps performed by the server to establish a user session.

FIG. 6 is a flow diagram illustrating an embodiment of the steps performed by the server to terminate a client session.

FIG. 7 is a flow diagram illustrating an embodiment of the steps performed by the server to reactivate a user session.

FIG. 8 is a state diagram illustrating an embodiment of the states that are assigned to a user session.

FIG. 9 is a flow diagram illustrating an embodiment of the relative timing of the user and client sessions.

FIG. 10 is a flow diagram illustrating the steps performed by the server associated with the relative timing of the user and client sessions of FIG. 9.

FIG. 11 is a more detailed block diagram of an embodiment of the memory element.

### DETAILED DESCRIPTION OF THE INVENTION

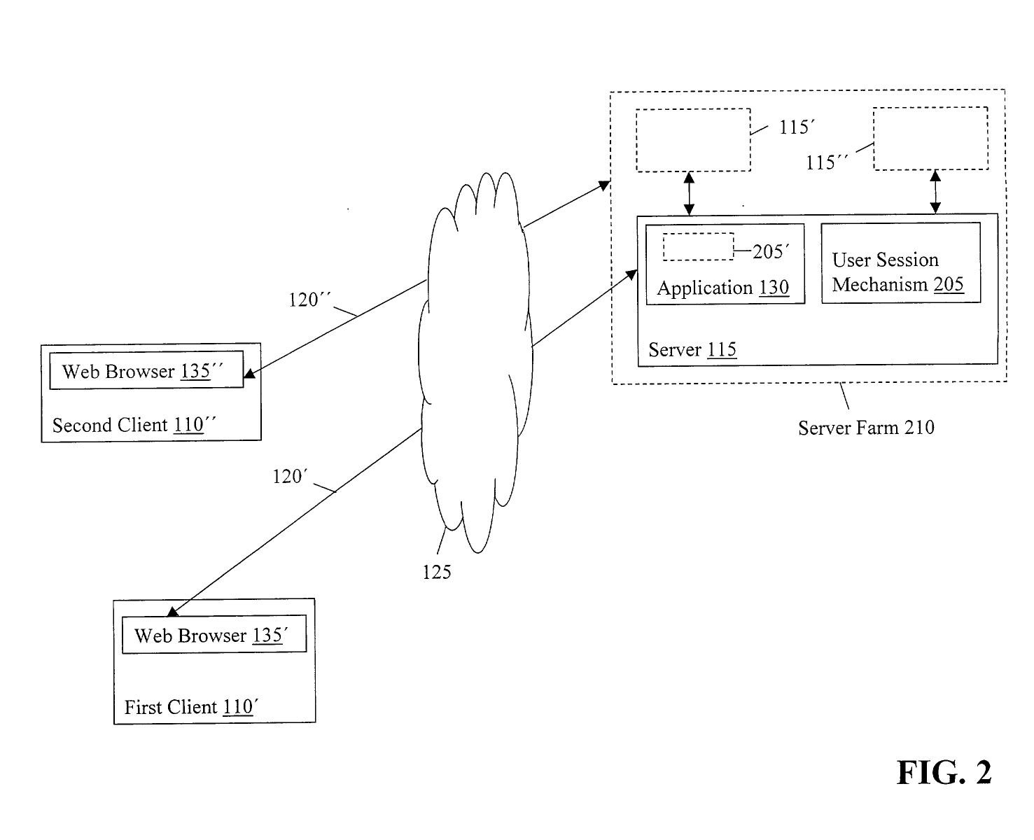

Referring to FIG. 2, an embodiment of a computer system 200 enabling communications over a client-server network 125 while removing many of the limitations of HTTP, or client, sessions is shown. In particular, the system 200 enables the server 115 to maintain state during communication sessions, enabling a user to access data stored during a first client communication session in a later communication session. Thus, in one embodiment, the access of the session data occurs after the first client communication session ends.

The computer system 200 includes a first client 110′, a second client 110″ (generally referred to below as client 110) and the server 115. In one embodiment, each client 110′, 110″ has a respective web browser 135′, 135″ (generally referred to below as web browser 135). Although shown with two clients 110′, 110″, the computer system 200 may have any number of clients (e.g., one, three, or fifty).

The client 110 can be any personal computer (e.g., based on a microprocessor from the x86 family, the Pentium family, the 680x0 family, PowerPC, PA-RISC, MIPS families), smart or dumb terminal, network computer, wireless device, information appliance, workstation, minicomputer, mainframe computer or other computing device. Operating systems supported by the client 110 can include any member of the WINDOWS family of operating systems from Microsoft Corporation of Redmond, Wash., MacOS, JavaOS, and various varieties of Unix (e.g., Solaris, SunOS, Linux, HP-UX, A/IX, and BSD-based distributions).

In one embodiment, the web browser 135 uses Secure Socket Layer (SSL) support for communications to the server 115. SSL is a secure protocol developed by Netscape Communication Corporation of Mountain View, Calif., and is now a standard promulgated by the Internet Engineering Task Force (IETF). The web browser 135 can alternatively connect to the server 115 using other security protocols, such as, but not limited to, Secure Hypertext Transfer Protocol (SHTTP) developed by Terisa Systems of Los Altos, Calif., HTTP over SSL (HTTPS), Private Communication Technology (PCT) developed by Microsoft Corporation of Redmond, Wash., and the Transport Level Security (TLS) standard promulgated by the IETF.

Although described above and below with a web browser 135, the client 110 may alternatively obtain content from the server 115 without a web browser 135. For instance, the client 110 may obtain content from the server 115 without accessing the web, instead using a communication device or module to directly communicate with the server 115. Moreover, although the protocol used for communication between the server 115 and the client 110 is described above and below as HTTP, any protocol can be used.

As stated above, in one embodiment each client 110 can download content from the server 115 over the network 125. The network 125 can be a local-area network (LAN), a wide area network (WAN), or a network of networks such as the Internet or the World Wide Web (i.e., web). In another embodiment, the first client 110′ and the second client 110″ communicate with the server 115 over different networks. In particular, the each client 110′, 110″ can communicate with the server 115 over a respective client-server communication channel 120′, 120″ (generally referred to below as client-server communication channel 120) that passes through the network 125.

Example embodiments of the communication channels 120′, 120″ include standard telephone lines, LAN or WAN links (e.g., T1, T3, 56 kb, X.25), broadband connections (ISDN, Frame Relay, ATM), and wireless connections. The connections over the communication channels 120′, 120″ can be established using a variety of communication protocols (e.g., HTTP, HTTPS, TCP/IP, IPX, SPX, NetBIOS, Ethernet, RS232, messaging application programming interface (MAPI) protocol, real-time streaming protocol (RTSP), real-time streaming protocol used for user datagram protocol scheme (RTSPU), the Progressive Networks Multimedia (PNM) protocol developed by RealNetworks, Inc. of Seattle, Wash., manufacturing message specification (MMS) protocol, and direct asynchronous connections).

In one embodiment, the server 115 delivers content (e.g., web pages) to the client 110. The server 115 can be any personal computer capable of communicating with the client 110, such as those described above with respect to the client 110. Moreover, the server 115 can support any operating system, examples of which are also given above for the client 110.

In one embodiment, the server 115 hosts an application 130 that is available for use by the client 110. Examples of such applications include word processing programs such as MICROSOFT WORD and spreadsheet programs such as MICROSOFT EXCEL, both manufactured by Microsoft Corporation of Redmond, Wash., financial reporting programs, customer registration programs, programs providing technical support information, customer database applications, or application set managers.

The server 115 also includes a user session mechanism 205. The user session mechanism 205 establishes and manages one or more user sessions between the server 115 and a user. In one embodiment, a user session includes a series of HTTP requests originating from the same identified user. In some embodiments, the request is addressed to the application 130. Because the request to establish a user session originates from the same user rather than from the same web browser 135 (and therefore client 110), the user session mechanism 205 can maintain a single user session with the same user from different web browsers and/or from different clients. Moreover, the user session mechanism 205 can establish and maintain multiple user sessions between the server 115 and the user over the same or multiple clients 110.

In one embodiment, the user session mechanism 205 is a software module executing within the server 115. The user session mechanism 205 may also be an external software module that “plugs into” the server 115 to add the user session capabilities to the server 115. Unlike an HTTP session, which is bounded by time, a user session between a particular user and the user session mechanism 205 is not dependent upon any time period. In further embodiments, a user session mechanism 205′ executes as part of the application 130, such as a subroutine or process of the application 130.

The server 115 can also be a member of a server farm 210, or server network, which is a logical group of one or more servers that are administered as a single entity. In one embodiment, the server farm 210 includes three web servers 115, 115′, 115″ (generally 115). Although the embodiment shown in FIG. 2 has three web servers 115, the server farm 210 can have any number of servers. In other embodiments, the server farm 210 is a protected network that is inaccessible by unauthorized individuals, such as a corporate Intranet, Virtual Private Network (VPN), or secure extranet. Additionally, the servers making up the server farm 210 may communicate over any of the networks described above (e.g., WAN, LAN) using any of the protocols discussed.

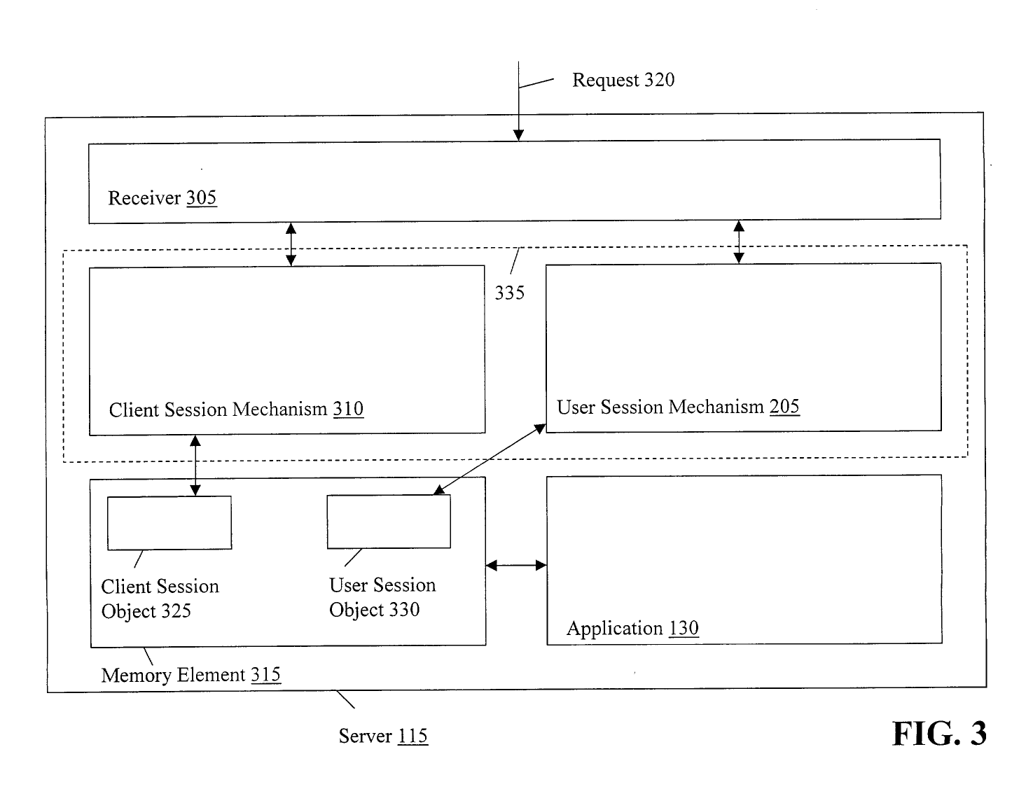

In more detail about the server 115 and also referring to FIG. 3, in one embodiment the server 115 includes a receiver 305, a client session mechanism 310, a memory element 315, the user session mechanism 205, and the application 130. These components enable the server 115 to create and maintain a user session even after terminating an established client session.

In particular and in one embodiment, the receiver 305 is a software module that receives one or more requests 320 to establish a communication session with the server 115 from the client 110. Thus, in one embodiment, the requests 320 are addressed to the receiver 305. The request 320 may be, for instance, a request to log into and use an application 130, such as MICROSOFT WORD. In one embodiment, the receiver 305 executes within the application 130. In other embodiments, the receiver 305 is a software module independently executing on the server 115 or part of another module of the server 115 (e.g., the user session mechanism 205).

The server 115 also includes a client session mechanism 310 in communication with the receiver 305. The client session mechanism 310 is a software module that establishes and manages an HTTP communication session between the server 115 and a client 110. As part of this management, the client session mechanism 310 stores and maintains session data associated with each communication session between the client 110 and the server 115. In one embodiment, the client session mechanism 310 stores the session data in the memory element 315.

The memory element 315 can be any standard memory device, such as dynamic RAM (DRAM), static RAM, synchronous DRAM (SDRAM), double data rate synchronous dynamic RAM (DDR SDRAM), electrically erasable programmable read-only memory (EEPROM), or a programmable read-only memory (PROM). The memory element 315 may be internally located or externally located from the server 115. Additional examples of memory elements 315 include a persistent database (e.g., a persistent user session database), a magnetic disk, or a magneto-optical drive. In some embodiments, the application 130 also accesses and stores information in the memory element 315.

As described in more detail below and in one embodiment, the client session mechanism 310 can create a client session object 325 for storing session data associated with one or more client sessions. Moreover, the user session mechanism 205 can also create a user session object 330 for storing session data associated with one or more user sessions.

At some point after the establishment of the client session, the server 115 will terminate the communication session. In one embodiment, the termination of the communication session is in response to a specific termination message. In some embodiments, the termination message can be a message sent from the client 110 or in response to an action performed by the user on the client 110, such as when the user closes the web browser 135. Alternatively, the termination message may be received when the server 115 does not receive any information from the client 110 with respect to the client communication session for a predetermined period of time. In other words, the server 115 can terminate the client session when the user of the client 110 remains idle for too long.

Once a client session ends, the server 115 typically discards the session data because the communication session is complete. To enable a user to return to the user's communication session at a later point and from the same or different client 110, however, the user session mechanism 205 maintains the session data after termination of the client session.

Moreover, any combination of the software modules 130, 205, 305, 310, 315, 325, 330 can be combined into a single module. For instance, the user session mechanism 205 and the client session mechanism 310 may be incorporated into a single session mechanism module 335. Further, any or all of the software modules 130, 205, 305, 310, 315, 325, 330, 335 can be internally or externally located from the server 115.

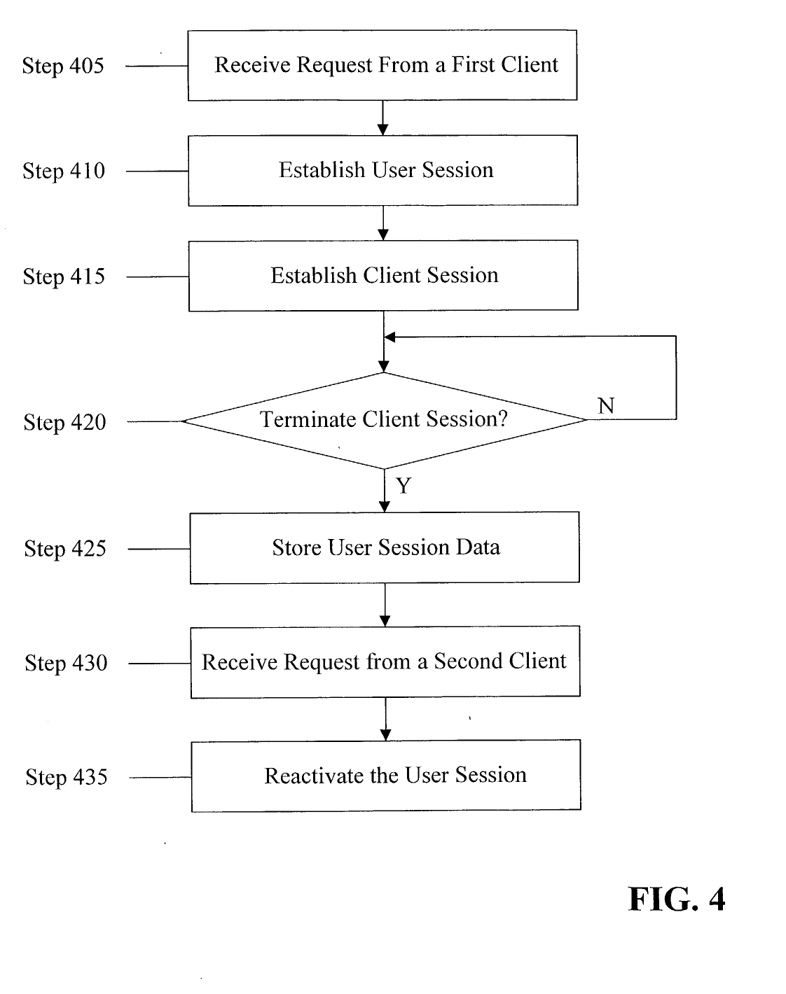

As an overview of the steps performed by the server 115 and also referring to FIG. 4, the receiver 305 receives (step 405) a request 320 from the first client 110′ to establish a communication session with the server 115, such as to access the application 130. In one embodiment, once the receiver 305 receives the request 320, the user session mechanism 205 then establishes (step 410) a user session between the user operating the first client 110′ and the server 115.

Next, the server 115 establishes (step 415) a client session between the first client 110′ and the server 115. As stated above, the client session mechanism 310 stores session data associated with and during the client session. The client session mechanism 310 continues to store session data during the client session until the server 115 determines, in step 420, to terminate the client session (e.g., in response to a timeout or receipt of a termination message). Upon such a determination, the server 115 terminates (step 425) the client session and the user session mechanism 205 takes over the responsibility of storing the user session data.

The server 115 then receives (step 430) a request from the second client 110″ to continue with the user's communication session. The user session mechanism 205 then reactivates (step 435) the user session. Despite the termination of the previous client session, the reactivation of the user session enables the user to continue the user's work on a different machine (e.g., the second client 110″) and at a different time.

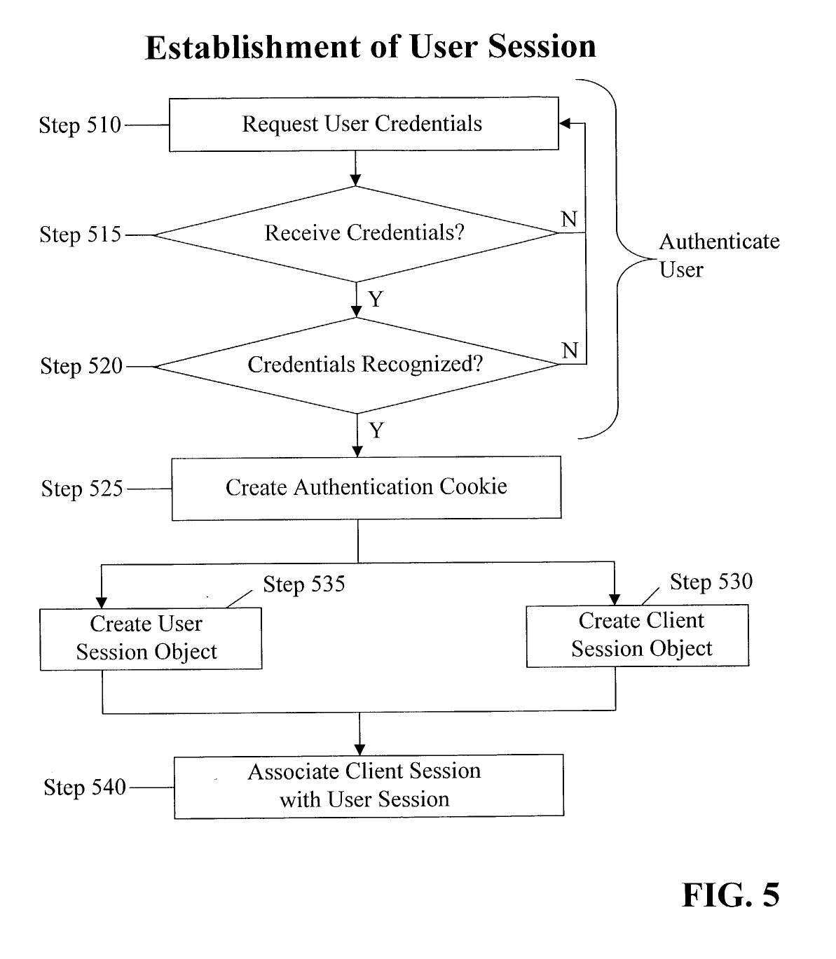

In more detail regarding the establishment of a user session and referring to FIG. 5, after the server 115 receives a request from the first client 110′ to establish the user session (as described above in step 405), the server 115 authenticates the user in steps 510-520 before establishing the user session. The authentication process includes the server 115 requesting (step 510) the user's credentials, such as the user's login name and password. In one embodiment, the user enters the user's credentials on the display of the web browser 135′ of the first client 110′ and the web browser 135′ transmits this information to the server 115. In other embodiments, the web browser 135′ automatically transmits this information to the server 115 for user verification. In yet other embodiments, the server 115 verifies the user via voice recognition or via biometric information (e.g., face recognition or eye scanning).

The server 115 waits to receive the user credentials (step 515) and then determines if the server 115 recognizes the received user credentials (step 520). In one embodiment, the server 115 checks the received user credentials with a list of user credentials that the server 115 stores in the memory element 315. If the server 115 does not recognize the user in step 520 (e.g., the server 115 does not recognize the received user credentials), then the server 115 repeats its request for the user's credentials. In one embodiment, the server 115 only requests the user's credentials a fixed number of times before terminating its communications with the first client 110′. The server 115 may also terminate its communications with the first client 110′ if the server 115 does not receive any user credentials in step 515 for a predetermined amount of time.

If the server 115 recognizes the user credentials and therefore identifies the user in step 520, the server 115 then creates an authentication cookie (step 525) for the establishment of a client session with the first client 110′. In one embodiment, the server 115 transports the authentication cookie to the first client 110′, for example, as part of one or more HTTP headers. Further, in some embodiments, the server 115 also retains a copy of the data transmitted in the authentication cookie for future use in identifying a user. In one embodiment, the server 115 then creates a client session object 325 associated with the authentication cookie (step 530). Thus, during the client communication session between the first client 110′ and the server 115, the server 115 stores session data associated with the client session in the client session object 325.

In step 535, the server 115 also creates a user session object 330 associated with the user previously authenticated in steps 510-520. The server 115 then associates the client session with the user session (step 540) so that the user session is relating to the client session for the same user. In one embodiment, the server 115 associates the client session with the user session by linking the client session object 325 with the user session object 330. In another embodiment, the server 115 associates the client session with the user session by maintaining a mapping between an identifier of the client session and an identifier of the user session. In one embodiment, the server 115 associates the objects 325, 330 so that the data that the server 115 stores in the client session object 325 is accessible to the user session object 330 even after the termination of the client session.

In one embodiment, when receiving a subsequent request 320 to establish a communications session after the user session mechanism 205 creates a user session, the server 115 compares the authentication cookie from the request header with the data associated with cookies that the server 115 stored for future user identification. If the information from the received cookie matches the stored data, the server 115 associates the current request 320 with a client session. In one embodiment, this association includes the creation of a client session within the same user session as previously created and used by the user.

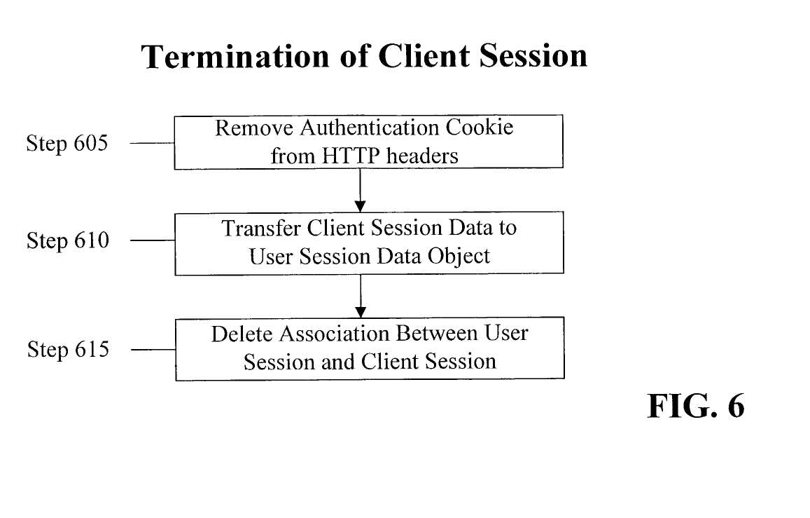

In more detail about the steps that the server 115 performs upon the termination of the client session with the first client 110′ and also referring to FIG. 6, the server 115 removes the authentication cookie from the HTTP headers (step 605) upon determining receipt of a termination message. The server 115 then transfers (step 610) the client session data previously stored in the client session object 325 to the user session object 330 so that the user can access the same session data at a later time despite the termination of the client session with the first client 110′. In step 615, the server 115 removes the association between the user session and the client session. In one embodiment, the server 115 deletes the client session object 325.

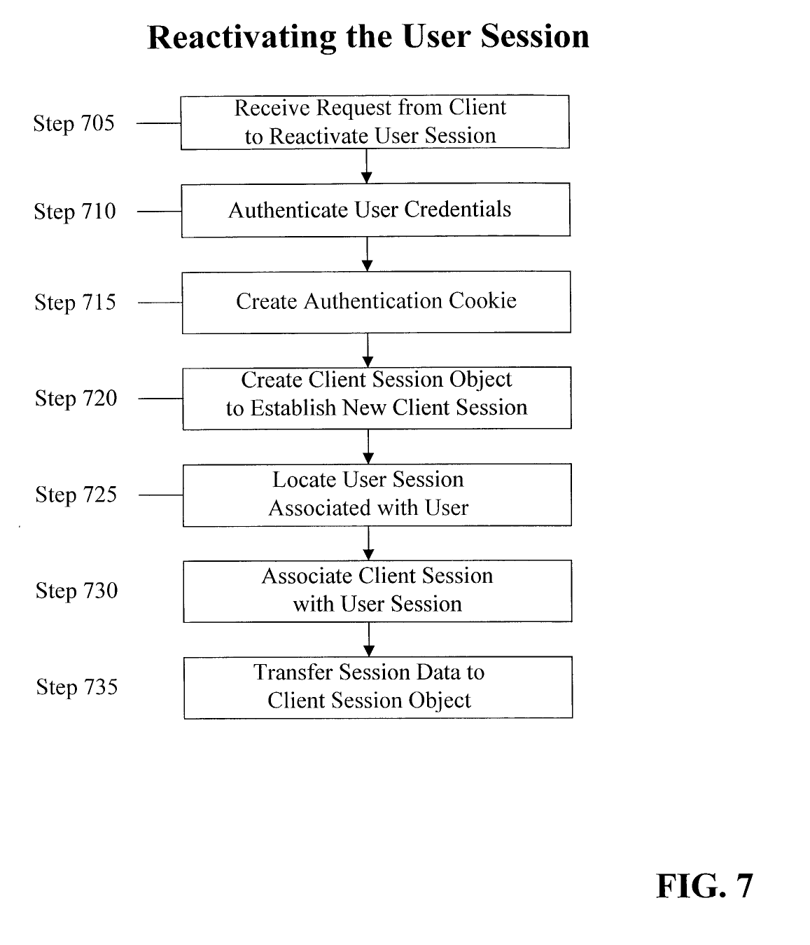

Referring to FIG. 7 and as briefly described above in FIG. 4 (steps 430 and 435), after the server 115 determines to terminate the client session with the first client 110′, the user may transmit a request from the second client 110″ to reactivate the same user session (step 705). This may occur, for instance, if a user who had connected to the server 115 from the user's office computer was now traveling for business. The user may prefer to continue the communication session previously established on the user's office computer, but the user likely only has access to a laptop (e.g., second client 110″) during his travels. In this situation, the user can use, for example, his laptop computer to transmit a request to the server 115 denoting the user's desire to reactivate the previous user session.

In step 710, the server 115 authenticates the user before enabling access to the session data created in the previous communication session. This authentication process is described in more detail above with respect to steps 510-520 of FIG. 5. Once authenticating the user, the server 115 then creates an authentication cookie (step 715), also described above in step 525 of FIG. 5. The server 115 also creates a client session object 325 to establish a new client session between the server 115 and the second client 110″ (step 720).

In one embodiment, the server 115 then searches the memory element 315 for the user session object 330 associated with the user's credentials (e.g., the user's name, the user's password, or any other user identifier). Upon location of the associated user session data and user session (step 725), the server 115 then associates the client session with the user session (step 730). The server 115 then retrieves and transfers (step 735) the session data previously transmitted to the user session object 330 in step 610 of FIG. 6 to the client session object 325 to enable the client session mechanism 310 to manage and update the session data.

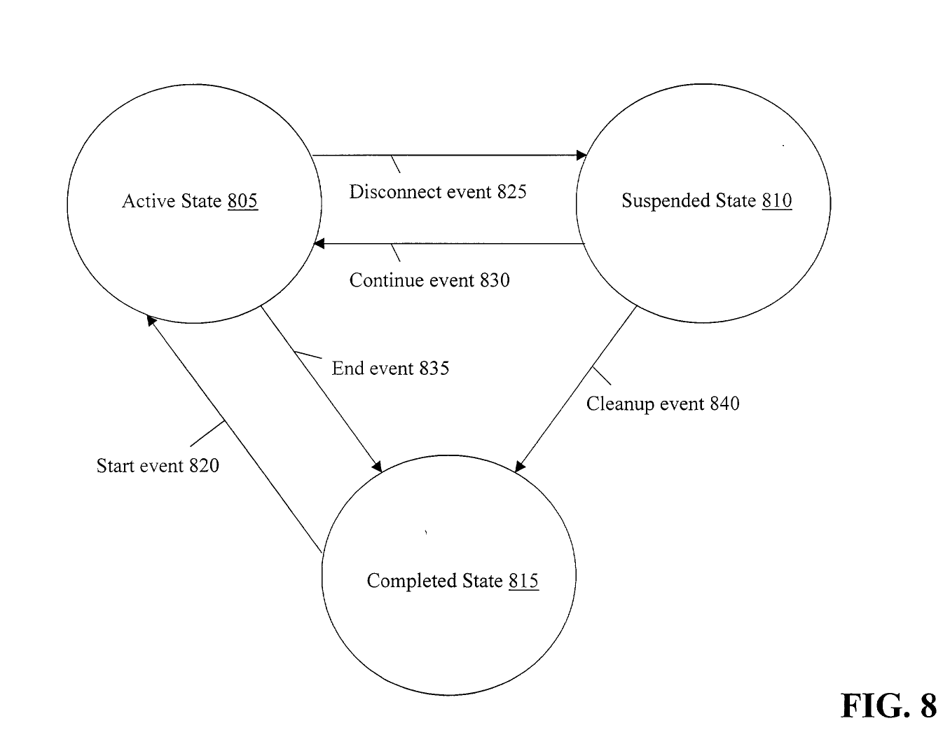

In more detail about the user sessions and referring to FIG. 8, in one embodiment, the user session mechanism 205 assigns a state to a user session to maintain state during the user communication session. The assigning of a state to a user session enables the reactivation of the user session. In particular, the user session mechanism can assign an active state 805, a suspended state 810, or a completed state 815 to the user session.

In one embodiment, the user session begins in the active state 805. The user session is in the active state 805 as long as a client session is established between a client 110 and the server 115. Thus, in one embodiment, the user session mechanism 205 assigns a user session an active state 805 in response to a start event 820. An example of the start event 820 includes receiving a request from a client 110 to establish user communications with the server 115, such as described above in step 405 (FIG. 4). The user session mechanism 205 maintains the user session in the active state 805 until a disconnect event 825 (e.g., a termination message) occurs. When the server 115 experiences a disconnect event 825, the user session mechanism 205 reassigns the state of the user session from an active state 805 to the suspended state 810. Thereafter, when the server 115 receives a continue event 830 (e.g., a request from the same user on another client to continue with the previous user session), the user session mechanism 205 reassigns the user session's state from the suspended state 810 back to the active state 805. Thus, the user session mechanism 205 can assign and reassign the user session state from the active state 805 to the suspended state 810 (and vice versa) as many times as a user prefers. Specifically, the user session mechanism 205 can change the state of the user session from active to suspended and vice versa as many times as the server receives a continue event 830 and/or a disconnect event 825.

Further, as described above, the server 115 ends the user session upon receipt of an end event 835 (e.g., via a user session termination message). When receiving an end event 835, the user session mechanism 205 converts the state of the user session from the active state 805 to the completed state 815. In one embodiment, the user session state can transition from the suspended state 810 to the completed state 815 in response to a cleanup event 840. In one embodiment, the cleanup event 840 is a command or action taken by an administrator (e.g., of the server 115, of the user session mechanism 205, etc.) In another embodiment, the user session state can transition from the suspended state 810 to the completed state 815 is for a management program to check the suspended sessions periodically to determine whether any suspended session has stayed in the suspended state 810 beyond a predetermined time period (e.g., one month). If such a suspended session exists, the user session will likely not be reactivated by the user in the future. Therefore, the management program can transition these session states to the completed state 815.

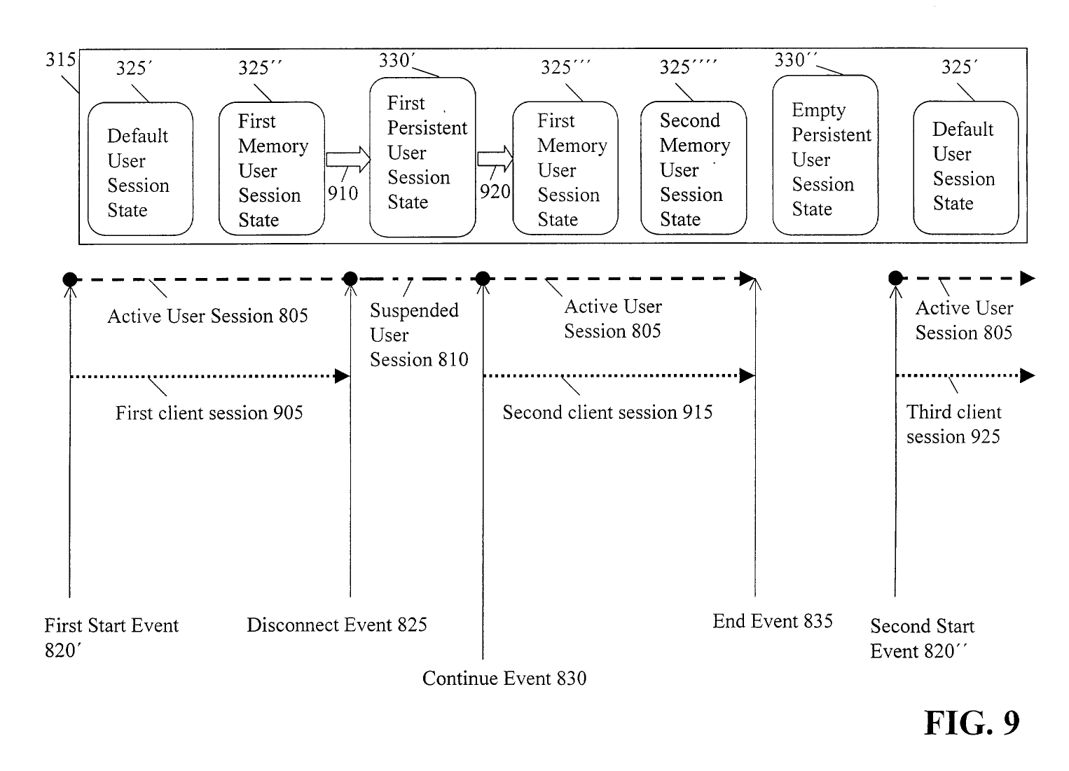

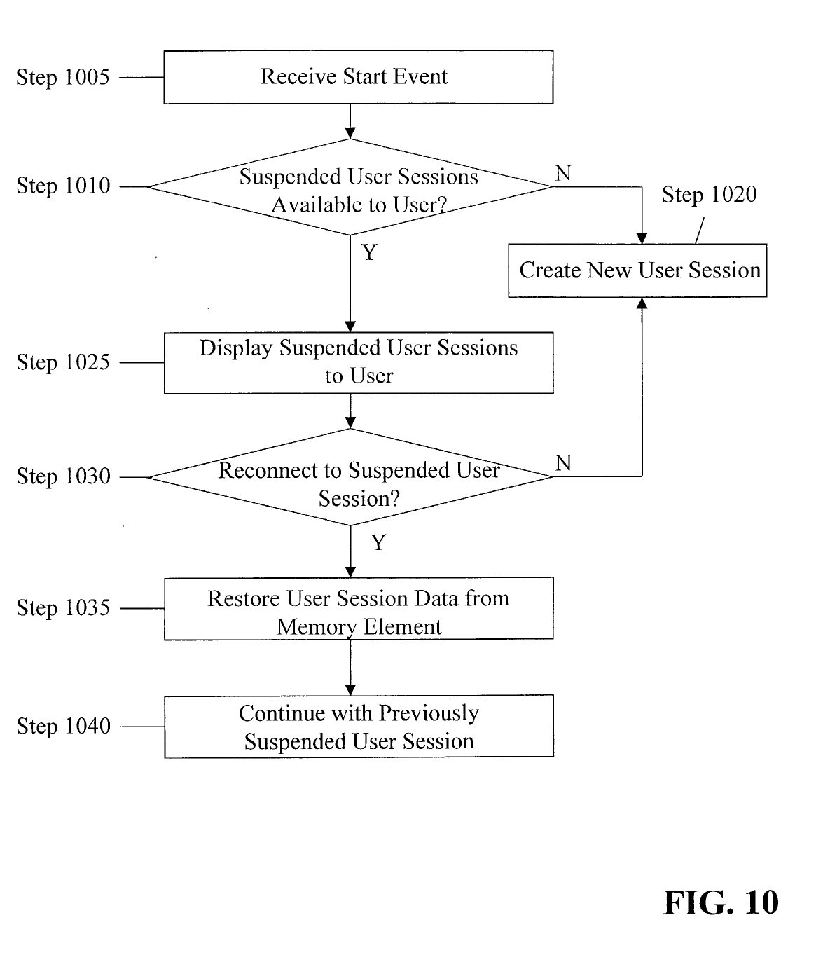

Referring to FIGS. 9 and 10, an embodiment of a timeline 900 of the state changes of a user session and the steps performed by the server 115 relating to the user session state are shown. The server 115 (i.e., the receiver 305) receives a first start event 820′ (e.g., a request to establish communications with the server 115) from the first client 110′ (step 1005). Upon receipt of the first start event 820′, the user session mechanism 205 checks the memory element 315 (e.g., persistent user session database) for any user sessions previously associated with the user (i.e., a user session in a suspended state 810) (step 1010). In one embodiment, this occurs after authenticating the user, as described above. If the user session mechanism 205 determines that no user session exists for the identified user in step 1010, the user session mechanism 205 creates a new user session (step 1020) for the user, as described above with respect to FIG. 5. Thus, as described above, when the user session mechanism 205 creates a first user session, the user client session mechanism 310 also creates a first client session 905. Moreover, the client session mechanism 310 creates an initial client session object 325′ and assigns a default user session state to this object 325′.

As the first client session 905 progresses, the client session mechanism 310 stores the session data associated with the first client session 905 in the initial client session object 325′, thereby causing a state transition of the object 325′ to an initial first state client session object 325″ having a first memory user session state. Later, the server 115 receives a disconnect event 825 to terminate the first client session 905. At this point, when the user session mechanism 205 transitions the user session to the suspended state 810, the user session mechanism 205 also transfers the session data from the initial first state client session object 325″ to a persistent user session object 330′ (shown with arrow 910). Thus, the user session mechanism 205 assigns a first persistent user session state to the persistent user session object 330′.

If, however, the user session mechanism 205 determines that a suspended user session 810 exists for the identified user in step 1010, such as when receiving a continue event 830 (e.g., a request from the second client 110″) after a disconnect event 825, the server 115 displays information about each suspended user session 810 available to the user (step 1025) on the client 110 which made the most recent communication request (e.g., second client 110″). In one embodiment, the user session mechanism 205 then determines if the user prefers to reconnect to a suspended user session 810 in step 1030, such as via receiving input from the user. If the server 115 determines that the user does not choose to reconnect to a suspended user session, the server 115 creates a new user session in step 1020.

If the user chooses to continue a suspended user session 810, the user session mechanism 205 waits for the user to select a suspended user session 810 from the display of user sessions if more than one suspended user session 810 exists for the identified user. In one embodiment, the server 115 considers the continue event 830 to be the selection of a suspended user session 810 from the server's display of suspended user sessions 810 on the client 110 (e.g., second client 110″).

Alternatively, the continue event 830 can be a direct request received from the second client 110″ to establish a communication session with the server 115. In this embodiment, the server 115 provides no choices to the user. Instead, the server 115 can connect to the most recently suspended user session 810, the earliest suspended user session 810, or a predetermined suspended user session 810. In some embodiments, the request indicates which user session 810 the user would like to reactivate.

Once the user session mechanism 205 determines that the user session mechanism 205 receives a continue event 830, the user session mechanism 205 transitions the suspended user session 810 to an active user session 805 and the client session mechanism 310 creates a second client session 915. Moreover, in one embodiment, the user session mechanism 205 restores the session data from the persistent user session object 330′ to a second first state client session object 325′″ (shown with arrow 920) (step 1035). This client session object 325′″ has the same session data as the initial first state client session object 325″ had before the ending of the first client session 905. Once the user session mechanism 205 restores the session data, the previously suspended user session continues (step 1040).

As the second client session 915 progresses, the client session mechanism 310 saves the new session data in the second first state client session object 325′″, thereby converting the client session object 325′″ into a second state client session object 325″″ having a second memory user session state. When the user requests to end the user session, the server 115 receives an end event 835. Upon receipt of the end event 835, the user session mechanism 205 then empties the persistent user session object 330′ having the first user session state, thereby producing an empty persistent user session object 330″. If the server 115 then receives a second start event 820′, the process repeats, such as with the creation of a third client session 925.

In a more detailed embodiment of the user session mechanism 205, the user session mechanism 205 can be written in any computer language or framework. For example, the user session mechanism 205 can be an Application Service Provider (ASP.NET) HTTP module or an HTTP handler. In one embodiment, the user session mechanism 205 is an HTTP event module which attaches to an HTTP event handler. Using the ASP.NET framework, the user session mechanism 205 can be an HTTP module added to the pipeline of HTTP Runtime to provide the user session capabilities described above.

In one embodiment, the user session mechanism 205 can pre/post process requests to provide the user session services. In particular and in one embodiment, the HTTP module preprocesses a request 320 by determining whether there is a need to begin or continue a user session. The HTTP module can post-process a request 320 to determine whether the user has asked to disconnect or end a user session.

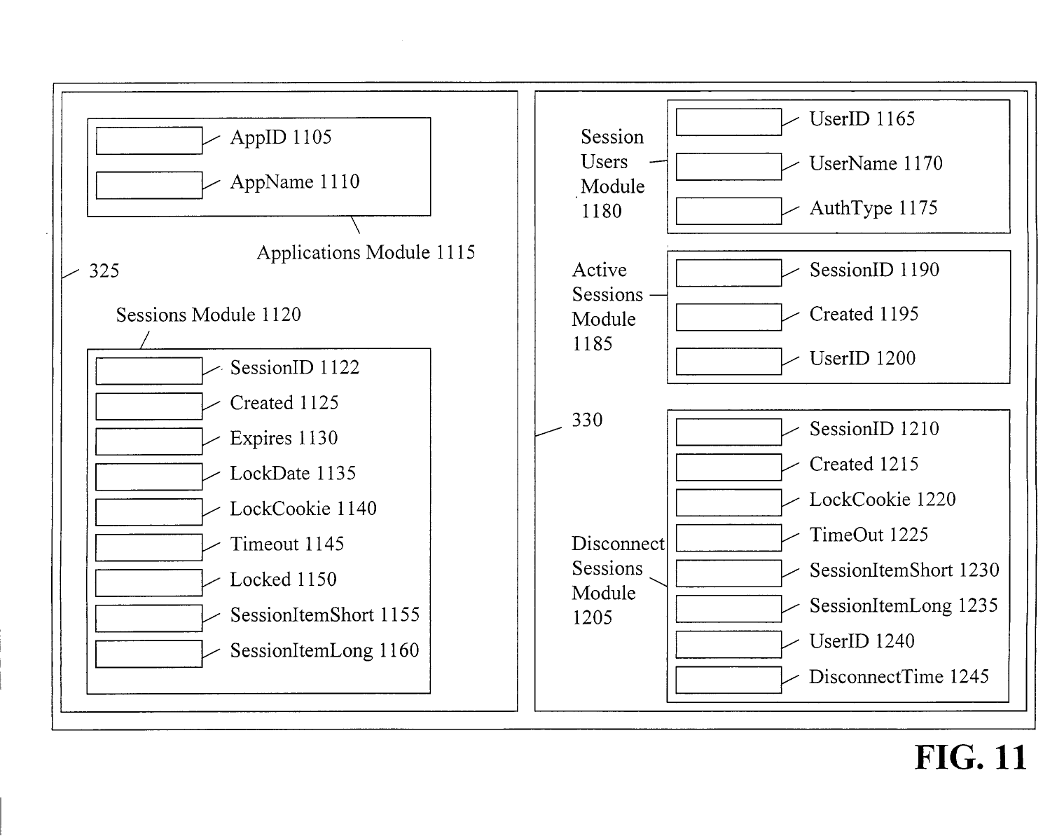

An embodiment of the user session data and the client session data that the server 115 stores in the memory element 315 is shown in FIG. 11. The client session object 325 includes, for example, the AppID field 1105 and the AppName field 1110 in an applications module 1115. In a sessions module 1120, the client session object 325 stores, for example, the SessionID field 1122, the Created field 1125, the Expires field 1130, the LockDate field 1135, the LockCookie field 1140, the Timeout field 1145, the Locked field 1150, the SessionItemShort field 1155, and the SessionItemLong field 1160. In one embodiment, the client session mechanism 310 stores the session data for client sessions in these fields. In some embodiments, these fields are fields of a table stored in a database 315.

In one embodiment, the client session mechanism 310 stores an identifier for the client communication session with the client 110 in the SessionID field 1122. The Created field 1125 can store a time stamp of when the client communication session was created. Similarly, the Expires field 1130 includes the time at which the client session expires. The LockDate field 1135 stores the date, if any, at which a client session is locked so that the session cannot be accessed. In one embodiment, the LockCookie field 1140 stores a boolean value (i.e., True or False) on whether a particular cookie is locked so that the data associated with the cookie is not accessible (e.g., during use, such as when the cookie is being updated). In another embodiment, the LockCookie field 1140 includes a lock type for the client session data in the memory element 315 if the session data is locked. In one embodiment, three possible lock types exist: a Read Lock, a Write Lock, and a Spin Lock. In one embodiment, the Read Lock is set to enable many programs to read the session data at the same time while preventing a program from writing the session data. Moreover, the Write Lock is set to prevent other programs from reading or writing the session data when one program is writing the session data. Additionally, in one embodiment, the Spin Lock is set to prevent access to the session data when one program is accessing (i.e., reading or writing) the session data. The Timeout field 1145 stores a time value at which the server 115 ends the client session because, for example, the server 115 does not receive input. In one embodiment, the Locked field 1150 is a boolean representing whether the data is locked and, therefore, access to the data is prohibited while the client session uses (e.g., writes and/or reads) the session data. The SessionItemShort field 1155 and the SessionItemLong field 1160 can be fields in which the server 115 stores session data.

The user session mechanism 205 stores additional information relative to the client session mechanism 310. In particular, the user session mechanism 205 stores a UserID field 1165, a UserName field 1170, and an AuthType field 1175 in a session users module 1180 of the user session object 330. In one embodiment, the UserID field 1165 includes a unique identifier for a user. The UserName field 1170 can include the name used to identify a user. In some embodiments, the AuthType field 1175 includes the method used to authenticate a user, such as via web forms, windows, or passport authentication.

The user session object 330 can also include an active sessions module 1185. The active sessions module 1185 includes a SessionID field 1190, a Created field 1195, and a UserID field 1200. In one embodiment, the SessionID field 1190 includes a unique identifier for a user session. The Created field 1195 includes the time at which the user session mechanism 205 created the user session. In one embodiment, the UserID field 1200 includes a unique identifier for the user involved in an active user session.

The user session object 330 can also include a disconnect sessions module 1205. The disconnect sessions module 1205 can include a SessionID field 1210, a Created field 1215, a LockCookie field 1220, a TimeOut field 1225, a SessionItemShort field 1230, a SessionItemLong field 1235, a UserID field 1240, and a DisconnectTime field 1245. In one embodiment, the LockCookie field 1220 includes a lock type (e.g., Read Lock, Write Lock, or Spin Lock) for the session data in the memory element 315 if the session data is locked. The Timeout field 1225 includes a predetermined time for terminating a client session after no action by the client 110 (e.g., no request 320 received from the client 110). The SessionItemShort field 1230 can store the session data when the data is smaller than a predetermined number of bytes (e.g., 7000). Likewise, the SessionItemLong field 1235 can store the session data when the data is larger than a predetermined number of bytes (e.g., 7000). In one embodiment, the DisconnectTime field 1245 includes the time when a user session is disconnected.

The enabling of a user session provides numerous advantages to the end user. For instance, the user session provides high mobility to users, as the users can begin a task in a first place and move to another place to continue work on the task. Moreover, rather than having to navigate around the web application 130 to find the correct spot to continue their work, the user can work immediately as soon as the user logs into the server 115. Additionally, the user session capability ensures that the user's partial work is not lost, even if the user has to leave before having a chance to suspend the application 130. There is also no time limit on the user session and a user can have multiple user sessions alive simultaneously so that the user can move from one task to another.

Similarly, many advantages exist to the web developer. For instance, the user session capability simplifies the feature that a web application can keep user session data for as long as a user desires. Further, in one embodiment, the introduction of a user session does not burden a web developer, as a high level of transparency exists with respect to programming session data in the same fashion as it is currently programmed. Moreover, user sessions can be used by any web application 130. User sessions can also enable web developers more freedom to focus on the business problems rather than on session data, potentially reducing development time of applications 130.

The present invention may be provided as one or more computer-readable programs embodied on or in one or more articles of manufacture. The article of manufacture may be a floppy disk, a hard disk, a CD ROM, a flash memory card, a PROM, a RAM, a ROM, a portable storage device, or a magnetic tape. In general, the computer-readable programs may be implemented in any programming language. Some examples of languages that can be used include C, C++, or JAVA. The software programs may be stored on or in one or more articles of manufacture as object code.

Having described certain embodiments of the invention, it will now become apparent to one of skill in the art that other embodiments incorporating the concepts of the invention may be used. Therefore, the invention should not be limited to certain embodiments, but rather should be limited only by the spirit and scope of the following claims.

What is claimed is:

1. A method for communicating over a client-server network, the method comprising the steps of:
(a) receiving, by a server, a request to establish communications with the server from a first client operated by a user;
(b) establishing, responsive to the received request, a user session between the server and the identified user;
(c) establishing, responsive to the received request, a client session between the first client and the server;
(d) storing, by the server, user session data in response to termination of the client session;
(e) receiving, by the server, a request to establish communications with the server from a second client operated by the user; and
(f) reactivating the user session.

2. The method of claim 1 wherein step (a) comprises receiving, by a server, a request to establish communications with the server, wherein the request identifies the user.

3. The method of claim 1 further comprising the step of receiving, by a server, user authentication credentials.

4. The method of claim 1 wherein step (a) comprises receiving, by a server, a HyperText Transfer Protocol (http) request to establish communications with the server.

5. The method of claim 1 wherein step (d) further comprises:
(d-a) receiving a termination message from the first client;
(d-b) terminating the client session between the first client and the server; and
(d-c) storing, by the server, user session data in response to the termination of the client session between the first client and the server.

6. The method of claim 1 wherein step (d) further comprises:
(d-a) waiting a predetermined period of time;
(d-b) terminating the client session between the first client and the server; and
(d-c) storing, by the server, user session data in response to the termination of the client session between the first client and the server.

7. The method of claim 1 wherein step (d) further comprises storing, by the server, user session data in a database in response to termination of the client session.

8. The method of claim 1 further comprising the step of assigning a state to the established user session.

9. The method of claim 8 wherein step (b) further comprises assigning an identifier to the established user session indicating that the user session is active.

10. The method of claim 8 wherein step (f) further comprises assigning an identifier to the user session indicating that the reactivated user session is active.

11. The method of claim 8 wherein step (d) further comprises assigning an identifier to the user session indicating that the user session is suspended.

12. The method of claim 1 further comprising the steps of:
(g) receiving a user session termination message to terminate the user session; and
(h) assigning an identifier to the user session indicating that the user session is completed.

13. The method of claim 12 further comprising the step of deleting the stored user session data.

14. The method of claim 1 wherein step (e) comprises:
(e-a) receiving, by the server, another request to establish communications with the server from at least one of the first client and the second client operated by the user; and
(e-b) determining, using the stored user session data, the existence of an established user session associated with the user.

15. The method of claim 14 further comprising the step of reactivating the user session in response to determining the existence of the established user session.

16. The method of claim 1 wherein step (d) further comprises the step of storing, by the server, at least one of a user identifier for the user, a name to identify the user, a method indicator denoting a method used to authenticate the user, a unique identifier for the user session, a time when the user session is created, a lock type for the session data, a timeout, the session data, and a disconnect time.

17. The method of claim 1 wherein step (b) further comprises:
(b-a) receiving, by the server, user credentials from the first client;
(b-b) authenticating the user using the user credentials;
(b-c) creating an authentication cookie;
(b-d) creating a client session object associated with the authentication cookie;
(b-e) creating a user session object associated with the user; and
(b-f) associating the client session with the user session.

18. The method of claim 17 further comprising the step of receiving another request from at least one of the first client and the second client to establish communications with the server.

19. The method of claim 18 further comprising comparing a cookie in a header of the another request with a cookie on the server before establishing a client session with the another request.

20. A server for communicating over a client-server network comprising:
(a) a receiver receiving a first request to establish a communication session with the server from a first client and a second request to establish a communication session with the server from a second client;
(b) a user session mechanism in communication with the receiver establishing a user session in response to the first request to establish a communication session with the server;
(c) a client session mechanism in communication with the receiver establishing a first client session in response to the first request to establish a communication session with the server; and
(d) a memory element storing user session data in response to termination of the first client session,
wherein the user session mechanism reactivates the user session in response to the receiver receiving the second request.

21. The server of claim 20 wherein the user session mechanism comprises an event handler.

22. The server of claim 20 wherein the user session mechanism comprises an HTTP module.

23. The server of claim 20 wherein the memory element comprises a database.

24. The server of claim 20 wherein the user session mechanism assigns a state to an established user session.

25. The server of claim 24 wherein the user session mechanism assigns a state further consisting of at least one of an active state, a completed state, and a suspended state.

26. A server for communicating over a client-server network comprising:
(a) means for receiving a request to establish communications with the server from a first client operated by a user;
(b) means for establishing, responsive to the received request, a user session with the identified user;
(c) means for establishing, responsive to the received request, a client session with the first client;
(d) means for storing user session data in response to termination of the client session;
(e) means for receiving a request to establish communications with the server from a second client operated by the user; and
(f) means for reactivating the user session.

27. An article of manufacture having computer-readable program means embodied therein for, the article comprising:
(a) computer-readable program means for receiving a first request to establish a communication session with the server from a first client and a second request to establish a communication session with the server from a second client;
(b) computer-readable program means for establishing a user session in response to the first request to establish a communication session with the server;
(c) computer-readable program means for establishing a first client session in response to the first request to establish a communication session with the server; and
(d) computer-readable program means for storing user session data in response to termination of the first client session,
wherein the computer-readable program means for establishing a user session in response to the first request reactivates the user session in response to the receiver receiving the second request.
